(19) United States
(12) Patent Application Publication
(10) Pub. No.: US 2012/0007718 A1
(43) Pub. Date: Jan. 12, 2012

(54) RADIO FREQUENCY IDENTIFICATION SIGNAL RECEIVING DEVICE AND POSITIONING SYSTEM USING THE SAME

(75) Inventor: Jiunn-Jye Lee, Taipei County (TW)

(73) Assignee: GETAC TECHNOLOGY CORPORATION, HSINCHU (TW)

(21) Appl. No.: 12/833,865

(22) Filed: Jul. 9, 2010

(51) Int. Cl. H04Q 5/22

(52) U.S. Cl. 340/10.4

(57) ABSTRACT

An RFID signal receiving device includes a receiving element disposed inside an electromagnetic absorption shell. Radio frequency signals emitted from a signal source can only enter the interior of the electromagnetic absorption shell through a window formed on the electromagnetic absorption shell. Therefore, only the radio-frequency signals which pass the windows can be received by the receiving element, so as to define a viewing angle of the receiving element through the window. Through the window, the directional receiving characteristic of the RFID signal receiving device is achieved by relatively a simpler structure.

### BACKGROUND OF THE INVENTION

1. Field of the Invention

The present invention relates to radio frequency identification (RFID) signal receiving device, and more particularly to a RFID signal receiving device having a viewing angle to receiving signals from specific direction and a positioning system utilizing the RFID signal receiving device.

2. Related Art

Rapid technological development makes the radio frequency identification (RFID) technology become a widely utilized wireless communication technology. In general, a basic front end of an RFID system includes a RFID signal receiving device and RFID tag.

One of the most important applications of the RFID system is the real time locating system (RTLS). In an RTLS, a plurality of the RFID signal receiving devices is utilized to receive the radio frequency signal from a single RFID tag. And then, the RTLS determines the distance between the RFID tag and each of the RFID signal receiving device. Finally, the RTLS derives the location of the RFID tag according to the distances. The aforementioned distance(s) is determined according to the decay in the strength of the radio frequency signal. Due to the natural characteristics of wireless signal, the radio frequency signal is usually interfered by environment factors. For example, the topographical features and the material of the stumbling blocks influence the propagation of the radio frequency signal in the air when using RFID system, so that the RFID system rarely obtains accurate distance(s) between the RFID tag and the RFID signal receiving device(s). Since accurate distance(s) is rarely obtained (a large error value is usually contained in the obtained distance value), the accuracy of the positioning system is negatively affected.

In view of that the accurate distance(s) between the RFID tag and the RFID signal receiving device(s) is rarely obtained, the position angle from the RFID tag to the RFID signal receiving device(s) is introduced as an additional parameter to determine the location of the RFID tag, so as to improve the accuracy of the positioning system. Due to the natural characteristics of wireless signal, the radio frequency signal is usually interfered by environment factors, for example, the topographical features and the stumbling blocks reflect, refract, or absorb the radio frequency signal propagated in the air, the position angle from the RFID tag to the RFID signal receiving device can not be obtained through an ordinary RFID signal receiving device.

R. O. C. Taiwan Utility Model M267550 discloses a positioning system. In M267550, a directional antenna is utilized in the RFID signal receiving device, so as to determine the position angle from the RFID tag to the RFID signal receiving device. In M267550, the directional antenna includes a plurality of antenna inductors arranged in a specific direction. The antenna inductors generate aerial inductance when the radio frequency signal is emitted from the specific direction. In other words, the directional antenna can only receive the radio frequency signal when the radio frequency signal is emitted from the specific direction. However, a large amount of the antenna inductors are required to build the directional antenna, the construction of the RFID signal receiving device in M264550 is complicated.

Instead of utilizing a directional antenna, the approach of U.S. Pre-grant Publication US20090322490 (also publish as R.O.C. Taiwan Publication TW200823770) is to emit a plurality of triggering signals in different directions and determine which triggering signal drives the RFID tag emits the radio frequency signal in response. However, US20090322490 (TW200823770) can only be applied to determine the location of a Passive-Type RFID Tag, and can not be applied to determine the location of an Active-Type RFID Tag.

Furthermore, to determine the location of the RFID tag, both US20090322490 (TW200823770) and M267550 have to evaluate the distance from the RFID tag and the RFID signal receiving device according to the decay in the strength of the radio frequency signal. It means that a large amount of hardware resources is required to evaluate the distance, and a large error value is usually contained in the distance obtained.

### SUMMARY OF THE INVENTION

In view of the aforementioned problem, the present invention provides a radio frequency identification (RFID) signal receiving device utilizing a simple structure to achieve directional receiving characteristics.

The RFID signal receiving device according to the present invention is provided to receive a radio frequency signal from a signal source. The RFID signal receiving device includes a electromagnetic absorption shell and a receiving element. The electromagnetic absorption shell is made of electromagnetic absorption material, and the electromagnetic absorption shell includes an accommodating space and at least one window communicating the accommodating space. The receiving element is disposed inside the accommodating space and receives the radio frequency signal through the window, so as to define a viewing angle of the receiving element.

In the RFID signal receiving device of the present invention, the viewing angle of the receiving element is defined by the window of the electromagnetic absorption shell. Therefore, the RFID signal receiving device achieves directional receiving characteristics with a simple structure, so as to determine the position angle from the signal source to the RFID signal receiving device.

In a positioning system in the prior art, the determination of the distance requires large amount of hardware resources. And an accurate distance value is rarely obtained, thus there is a large error value in the location obtained by the positioning system in the prior art. The present invention provides a positioning system to improve the accuracy of the positioning system with relatively low hardware resources.

The system of the present invention is provided to determine a possible location area in which a signal source is located. The positioning system includes a plurality of RFID signal receiving devices and a backend server. Each of the RFID signal receiving devices has a viewing angle and is able to receive the radio frequency signal when the signal source is within the radio frequency signal. The backend server is electrically coupled to the RFID signal receiving devices for determining the possible location area in which the signal source is located according to signal receiving status of the RFID signal receiving devices.

The backend server determines an overlapping region of the angles in which the signal source is located as the possible location area. To the backend server, it is not required to evaluate the decay in the strength of the radio frequency signal or to calculate the relative distance from the RFID signal receiving device to the signal source. Therefore, the positioning system of the present invention does not consume large amount of hardware resources to position the signal source, so as to reduce the loading on the backend server. And more over, the problem due to the inaccurate distance is prevented.

### BRIEF DESCRIPTION OF THE DRAWINGS

The present invention will become more fully understood from the detailed description given herein below for illustration only, and thus not limitative of the present invention, wherein:

FIG. 1A is a perspective view of a RFID signal receiving device according to a first embodiment of the present invention;

FIG. 1B is a top view of the RFID signal receiving device according to the first embodiment of the present invention;

FIG. 2A is a perspective view of a RFID signal receiving device according to a second embodiment of the present invention;

FIG. 2B is a top view of the RFID signal receiving device according to the second embodiment of the present invention;

FIG. 3A is a perspective view of a RFID signal receiving device according to a third embodiment of the present invention;

FIG. 3B is a top view of the RFID signal receiving device according to the third embodiment of the present invention;

FIG. 4A is a perspective view of a RFID signal receiving device according to a fourth embodiment of the present invention;

FIG. 4B is a top view of the RFID signal receiving device according to the fourth embodiment of the present invention;

FIG. 5 is a top view of a RFID signal receiving device according to a fifth embodiment of the present invention;

FIG. 6 is a top view of a positioning system according to a sixth embodiment of the present invention.

### DETAILED DESCRIPTION OF THE INVENTION

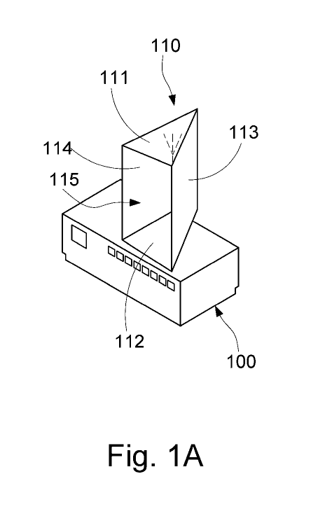

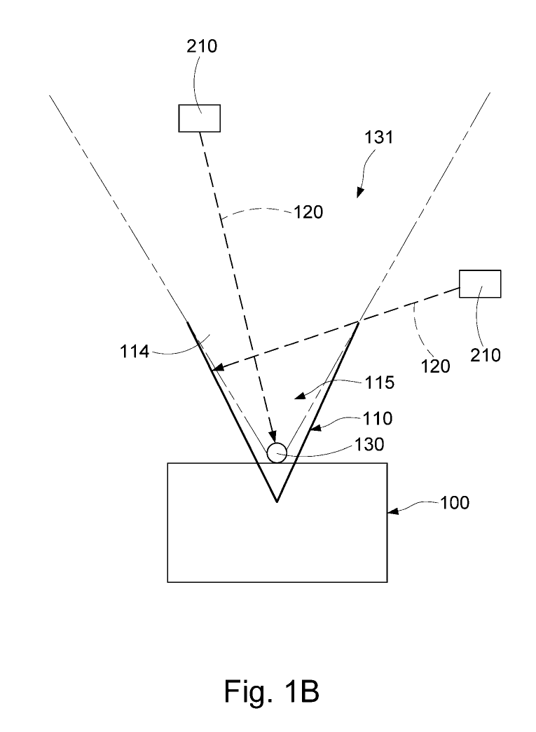

Please refer to FIGS. 1A and 1B, a radio frequency identification (RFID) signal receiving device 100 according to a first embodiment of the present invention is shown. The RFID signal receiving device 100 is provided to receive a radio frequency signal 120 emitted from a signal source 210. The RFID signal receiving device 100 includes an electromagnetic absorption shell 110 and at least one receiving element 130. The signal source 210 can be a Passive-Type RFID Tag or an Active-Type RFID Tag. In the first embodiment, the Active-Type RFID Tag is utilized as the signal source 210.

Please refer to FIGS. 1A and 1B, the electromagnetic absorption shell 110 is a hollow prism, i.e. a prism having triangular cross-section, and the prism includes a top surface 111 and a bottom surface 112. The prism as the electromagnetic absorption shell 110 also includes a plurality of the lateral surfaces 113 connecting the surface 111 to the bottom surface 112.

The electromagnetic absorption shell 110 further includes an accommodating space 115 defined therein and at least one window 114 communicating the accommodating space 115. The accommodating space 115 is defined by the top surface 111, the bottom surface 112, and the lateral surfaces 113. And the window 114 is disposed in one of the lateral surfaces 114. The electromagnetic absorption shell 110 is made of electromagnetic absorption material. The electromagnetic absorption material is material that electromagnetic energy of electromagnetic wave is taken up when electromagnetic wave is propagated therein. That is, electromagnetic absorption material effectively takes up electromagnetic energy of the radio frequency signal 120 when the radio frequency signal 120 is propagated in the electromagnetic absorption shell 110. Therefore, the electromagnetic absorption material effectively prevents the radio frequency signal 120 from penetrating the electromagnetic absorption shell 110 or being reflected by the electromagnetic absorption shell 110.

In the first embodiment, the electromagnetic absorption shell 110 includes only one window 114. However, the number, the position, and the configuration of the window 114 can be varied according to the requirement by a person skilled in the art.

The electromagnetic absorption material can be soft magnetic metal powder, soft magnetic ceramic powder, dielectric ceramic powder, or the combination thereof. According to the frequency variation and bandwidth of the radio frequency signal, a composite material includes plural electromagnetic absorption materials is preferred to absorb electromagnetic waves having various frequencies and a wide bandwidth, rather than a electromagnetic absorption material having only one single component to absorb electromagnetic wave having a specific frequency and a narrow bandwidth.

Please refer to FIG. 1B, the receiving element 130 is disposed inside the accommodating space 115 of the electromagnetic absorption shell 110. As aforementioned, the radio frequency signal is effectively absorbed when the radio frequency signal is propagated in the solid portion of the electromagnetic absorption shell 110. And, the energy of the radio frequency signal that penetrating the electromagnetic absorption shell 110 or being reflected by the electromagnetic absorption shell 110 is greatly reduced. Therefore, receiving element 130 is limited to receive the radio frequency signal 120 through the window 114. From the receiving element 130 to the edge of the window 114, a viewing angle 131 of the receiving element 130 is defined, and the receiving element 130 can receive the radio frequency signal when the signal source 210 is located within the receiving angle 131.

Through the electromagnetic absorption shell 110, the receiving element 130 can only receives the radio frequency signal 120 passing the window 114. Furthermore, it is able to be determined that whether the signal source 210 is located within the receiving angle 131 by judging whether the receiving strength of the radio frequency signal 120 received by the receiving element 130 exceeds a pre-determined strength, so as to determining the location of the signal source 210.

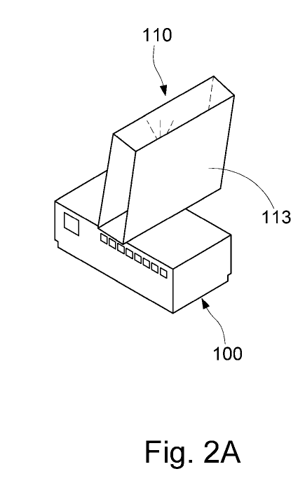

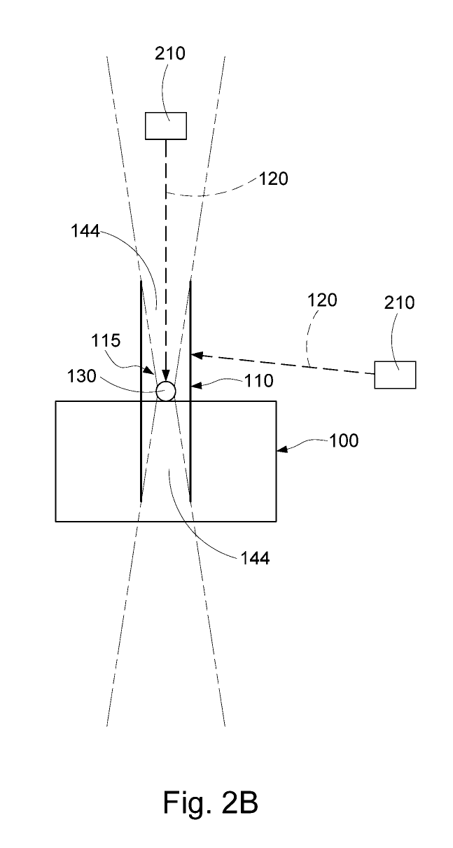

Please refer to FIGS. 2A and 2B, in which an RFID signal receiving device 100 according to a second embodiment of the present invention is shown. The RFID signal receiving device 100 is provided for receiving a radio frequency signal 120 emitted from a signal source 210. The difference between the second embodiment and the first embodiment is that the configuration of the electromagnetic absorption shell 110 in the second embodiment is different from that in the first embodiment.

In the second embodiment, the electromagnetic absorption shell 110 is a hollow hexahedron having a plurality of planar surfaces, and more specifically, the top view of the hexahedron shows a rectangle. And the window 114 is disposed in one of the planar surfaces of the electromagnetic absorption shell 110. In second embodiment, the electromagnetic absorption shell 110 includes more than one window 114, and more specifically, the electromagnetic absorption shell 110 has two windows 114. The receiving element 130 is disposed inside the accommodating space 115 of the electromagnetic absorption shell 110, and the windows 114 are respectively disposed in two opposite planar surfaces of the electromagnetic absorption shell 110. Therefore, two viewing angles 131 of the receiving element 130 are defined through the two windows 114, the two viewing angles 131 extend toward adverse directions.

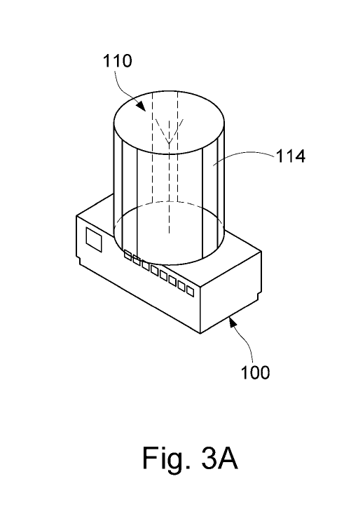

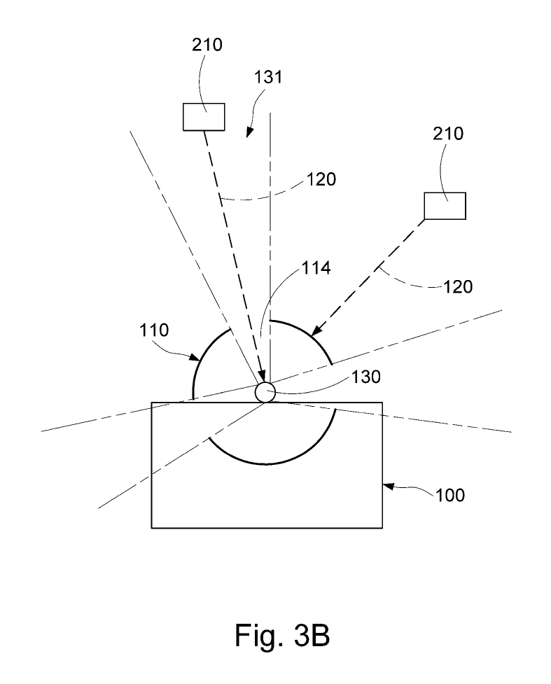

Please refer to FIGS. 3A and 3B, a radio RFID signal receiving device 100 according to a third embodiment of the present invention is shown. The difference between the third embodiment and any one of the aforementioned embodiments is that the configuration of the electromagnetic absorption shell 110 in the third embodiment is different from that in the aforementioned embodiments.

In the second embodiment, the electromagnetic absorption shell 110 is a hollow column, and more specifically, the top view of the column shows a circle or an ellipse. And a plurality of windows 114 is formed on the peripheral surface of the column. In the third embodiment, the number of the windows 114 is three, and each of the windows (114) is disposed in the peripheral surface of the column and spaced from each other. Therefore, three viewing angles 131 of the receiving element 130 are defined through the three windows 114, the three viewing angles 131 extend toward different directions.

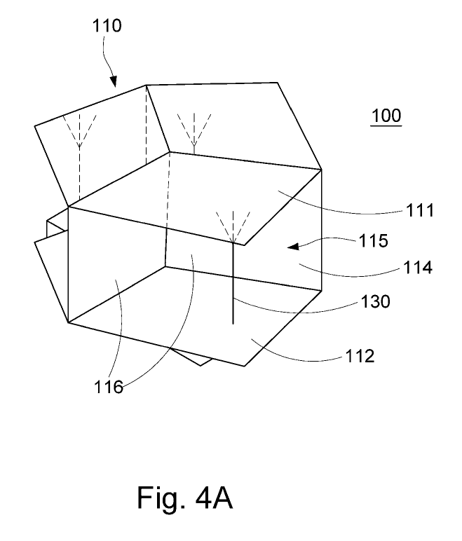

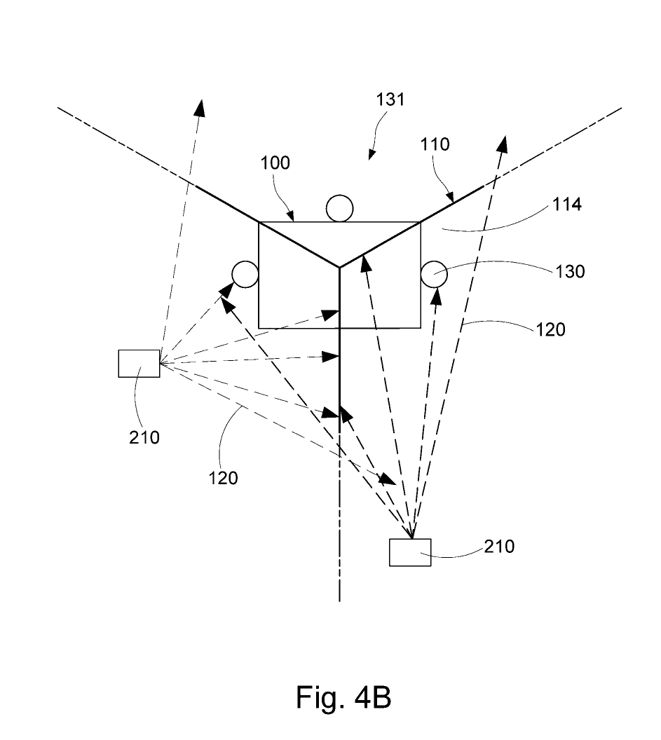

Please refer to FIGS. 4A and 4B, in which an RFID signal receiving device 100 according to a fourth embodiment of the present invention is shown. The RFID signal receiving device 100 is provided for receiving a radio frequency signal 120 emitted from a signal source 210. The difference between the fourth embodiment and any one of the aforementioned embodiments is that the configuration of the electromagnetic absorption shell 110 in the fourth embodiment is different from that in the aforementioned embodiments, and the RFID signal receiving device 100 includes a plurality of the receiving elements 130.

The electromagnetic absorption shell 110 in the fourth embodiment includes a top surface 111, a bottom surface 112, and a plurality of electromagnetic absorption partitions 116. An accommodating space 115 of the electromagnetic absorption shell 110 is defined between the top surface 111 and the bottom surface 112. And, the accommodating space 115 is divided into a plurality of subspaces by the electromagnetic absorption partitions 116. Each of the subspace is equipped with one receiving element 130 disposed therein. And each of the receiving elements 130 is disposed corresponding to one window 114 disposed on the electromagnetic absorption shell 110. That is, each receiving element 130 in different subspace is disposed corresponding to different window 114. In the RFID signal receiving device 110 of the fourth embodiment, each receiving element 130 is disposed corresponding to different window 114 and extending lines from each receiving element 130 to the edge of the corresponding window 114 extend toward different directions. Therefore, different viewing angle 131 corresponding to different receiving element 130 is defined. Furthermore, it is able to determine the location of the signal source by judging which one of the receiving elements 130 receives the signal source emitted from the signal source 210.

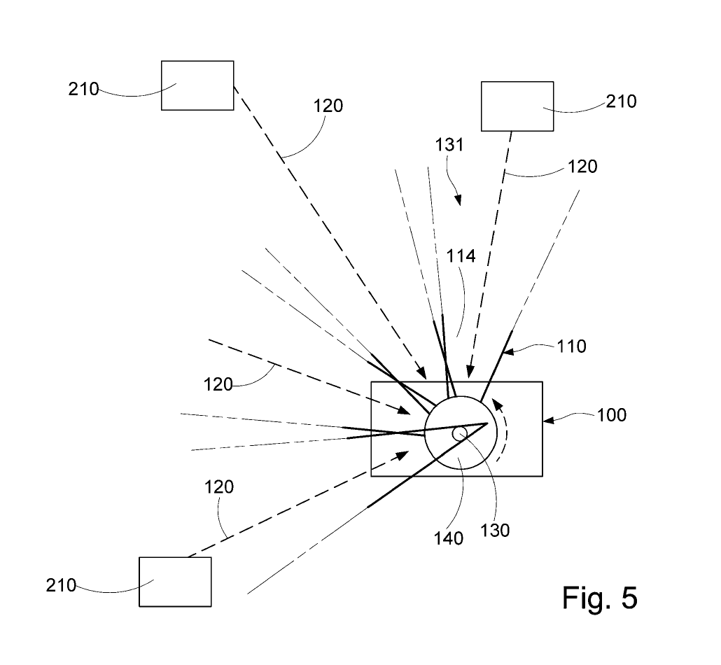

Please refer to FIG. 5, an RFID signal receiving device 100 according to a fifth embodiment of the present invention is shown. The difference between the fifth embodiment and any one of the aforementioned embodiments is that the RFID signal receiving device 100 in the fifth embodiment further includes a motor 140 connected to the electromagnetic absorption shell 110. The motor 140 is provided for driving the electromagnetic absorption shell 110 to rotate on the RFID signal receiving device 100, so that the position of the window 114 is changed as the electromagnetic absorption shell 110 rotates. Since the position of the window 140 is changed, the viewing angle 131 of the receiving element 130 also shifts to receive radio frequency signals for different signal source 210 located at different orientations. Through the rotation of the motor 140 and the shift in the viewing angle 131, the location of the signal source 210 can be obtained.

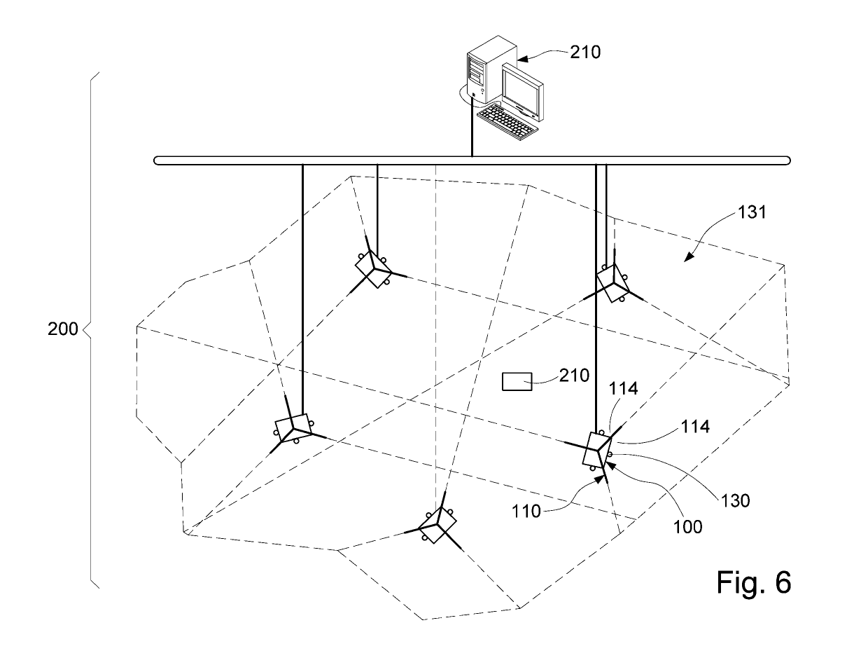

Please refer to FIG. 6, a position system 200 according to a sixth embodiment of the present invention is shown. The position system 200 is provided for determine a possible location area in which the signal source 210 is located.

The positioning system 200 includes a plurality of RFID signal receiving device 100 disposed in different area. Each RFID signal receiving device 100 can be any one of the RFID signal receiving devices 100 described in the first to the fifth embodiments. Each of the RFID signal receiving devices 110 respective includes at least one viewing angle 131 and is able to receive the radio frequency signal when the signal source 210 is within the corresponding viewing angle 131.

Preferably, the signal source 210 is an Active-Type RFID Tag that actively emits the radio frequency signal to be received by the RFID signal receiving device 100. However, the signal source 210 is not limited to the Active-Type Tag, the signal source 210 in the first to the sixth embodiment of the present invention can be a Passive-Type RFID Tag. If the Passive-Type RFID Tag is utilized as the signal source 210, the each of the RFID signal receiving devices 100 periodically emits a triggering signal to drive the signal source 210 to emit the radio frequency signal 120 in response.

Similar to the first to the fifth embodiments, each RFID signal receiving device 100 in the sixth embodiment respectively includes an electromagnetic absorption shell 110 and at least one receiving element 130. The electromagnetic absorption shell 110 includes an accommodating space 115 defined therein and at least one window 114 communicating the accommodating space 115. The receiving element 130 is disposed inside the accommodating space 115 and receives the radio frequency signal through the window 114, so as to define at least one viewing angle of each RFID signal receiving device 110 through the window 114. The electromagnetic absorption shell 110 is made of electromagnetic absorption material.

The positioning system 200 further includes a backend server 200 electrically coupled to the RFID signal receiving devices 100.

Please refer to FIG. 6, defined by each window 114 of each RFID signal receiving device 100, each RFID signal receiving device 100 includes at least one viewing angle 131, and the viewing angles 131 are recorded in the backend server 220.

When the signal source 210 emits the radio frequency signal 120 among the RFID signal receiving devices 100 and the signal source 210 is within one or more specific viewing angles 131, the radio frequency signal is received by the RFID signal receiving device(s) 100 corresponding to the aforementioned one or more specific viewing angles 131. Then, the backend server 220 determines the possible location area in which the signal source 210 is located according to signal receiving status of the RFID signal receiving devices 100. The backend server 120 determines one or more viewing angles 131 in which the signal source 120 is located according to whether the corresponding RFID signal receiving devices 100 receive the radio frequency signal, and then determines an overlapping region of the angles 131 in which the signal source 120 is located as the possible location area.

In the positioning system 200 of the present invention, the possible location area of the signal source 210 is determined by overlapping the viewing angles 131. Neither the estimating for the decay in strength of the received radio frequency signal nor the evaluation for the distance between the signal source 210 and each RFID signal receiving device 100 is required. Therefore, the hardware resources required for determining the location of the signal source 210 is reduced, and the accuracy of positioning the signal source 210 is improved.

In the RFID signal receiving device 100 of the present invention, the directional receiving characteristics is achieved through the configuration of the electromagnetic absorption shell 110 and the window 140. And the positioning system 200 utilizes plural RFID signal receiving devices 100 to receive the radio frequency signal from the signal source 210, the strength of the received radio frequency signal is relative strong when the signal source 210 is within the viewing angles 131 of the RFID signal receiving devices 100, thus the possible location area obtained by the positioning system 200 is more precise than that obtained by the positioning systems in the prior art.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A radio frequency identification (RFID) signal receiving device for receiving a radio frequency signal, comprising:
an electromagnetic absorption shell, made of electromagnetic absorption material, and including an accommodating space defined therein and at least one window communicating the accommodating space; and
at least one receiving element, disposed inside the accommodating space and receiving the radio frequency signal through the window, so as to define a viewing angle of the receiving element by the window.

2. The RFID signal receiving device as claimed in claimed 1, wherein the electromagnetic absorption shell is a hollow prism including a top surface, a bottom surface and a plurality of lateral surfaces connected the top surface to the bottom surface, and the window is disposed in one of the lateral surfaces.

3. The RFID signal receiving device as claimed in claim 1, wherein the electromagnetic absorption shell is a hollow hexahedron including a plurality of planar surfaces, and the window is disposed in one of the planar surfaces.

4. The RFID signal receiving device as claimed in claim 1, wherein the electromagnetic absorption shell is a hollow column, and the window is disposed in a peripheral surface of the column.

5. The RFID signal receiving device as claimed in claim 4, wherein the electromagnetic absorption shell includes a plurality of windows, and each of the windows is disposed in the peripheral surface of the column and spaced from each other.

6. The RFID signal receiving device as claimed in claim 1, wherein the electromagnetic absorption shell includes a top surface, a bottom surface, and a plurality of electromagnetic absorption partitions, the accommodating space is defined between the top surface and the bottom surface, the accommodating space is divided into a plurality of subspaces by the electromagnetic absorption partitions, each of the subspace is equipped with one receiving element disposed therein, and each of the receiving elements is disposed corresponding to one window of the electromagnetic absorption shell.

7. The RFID signal receiving device as claimed in claim 1, further comprising a motor for driving electromagnetic absorption shell to rotate.

8. A positioning system, for determine a possible location area in which a signal source is located, and the signal source emits a radio frequency signal, the positioning system comprising:
a plurality of the radio frequency identification signal receiving device, respectively including a viewing angle and be able to receive the radio frequency signal when the signal source is within the corresponding viewing angle; and
a backend server, electrically coupled to the RFID signal receiving devices for determine the possible location area in which the signal source is located according to radio frequency signal receiving status of the RFID signal receiving devices.

9. The positioning system as claimed in claimed 8, wherein each of the RFID signal receiving devices includes:
a electromagnetic absorption shell, including a window; and
a receiving element disposed inside the electromagnetic absorption shell and having a viewing angle defined by the window.

10. The positioning system as claimed in claim 9, wherein the electromagnetic absorption shell is made of electromagnetic absorption material, the electromagnetic absorption shell includes an accommodating space defined therein, and the window communicates the accommodating space.

11. The positioning system as claimed in claim 9, wherein each of the RFID signal receiving devices periodically emits a triggering signal to drive the signal source to emit the radio frequency signal in response.

12. The positioning system as claimed in claimed 8, wherein the backend server determines one or more viewing angles in which the signal source is located according to whether the corresponding RFID signal receiving devices receive the radio frequency signal, and then determines a overlapping region of the angles in which the signal source is located as the possible location area.
